(19) United States
(12) Patent Application Publication
(10) Pub. No.: US 2017/0217130 A1
(43) Pub. Date: Aug. 3, 2017

(54) MULTILAYER STRUCTURE AND THERMOFORMED ARTICLES MADE THEREFROM

(71) Applicant: Dow Global Technologies LLC, Midland, MI (US)

(72) Inventors: Lamy J. Chopin, III, Missouri City, TX (US); Fanny Deplace, Lake Jackson, TX (US); Brian W. Walther, Clute, TX (US); Claudia Hernandez, Lake Jackson, TX (US); Felipe Martinez Barreneche, Houston, TX (US)

(73) Assignee: Dow Global Technologies LLC, Midland, MI (US)

(21) Appl. No.: 15/515,546

(22) PCT Filed: Oct. 1, 2015
(86) PCT No.: PCT/US2015/053458

§ 371 Date: Mar. 29, 2017

Related U.S. Application Data
(60) Provisional application No. 62/058,197, filed on Oct. 1, 2014.

(51) Int. Cl. B32B 7/12; B32B 27/32; B32B 27/30; B32B 27/08; B32B 27/18

(52) U.S. Cl. CPC B32B 7/12; B32B 27/08; B32B 27/18; B32B 27/30; B32B 27/32

(57) ABSTRACT

A multilayer structure comprising at least one barrier layer, said barrier layer including less than or equal to 12 percent, by weight of the barrier layer, of an anhydride and/or carboxylic acid functionalized ethylene/alpha-olefin interpolymer having a density in the range of from 0.855 to 0.900 g/cm³; and having a melt viscosity less than 50,000 cP at 350° F. (177° C.); and at least 60 percent, by weight of the barrier layer, of EVOH having from 10 to 32 mole percent units derived from ethylene monomer is provided. Further provided are thermoformed articles made therefrom.

### FIELD OF INVENTION

The disclosure relates to a multilayer structure and thermoformed articles made therefrom.

### BACKGROUND OF THE INVENTION

The use of multilayer structures and/or packages made with high-barrier (i.e. low ethylene content, below 34 mole percent (mol %) ethylene) ethylene vinyl alcohol polymers (EVOH) is desirable in order to achieve a good shelf life for sensitive food contents. However when these polymers are very stiff and brittle they have a tendency to crack and fracture, i.e. to fibrillate when they are oriented/stretched during thermoforming. Many current thermoforming film structures use EVOH grades having equal to or greater than 38 mol % units derived from ethylene. Such high ethylene content EVOH polymers are slightly less stiff, but when used in multilayer structures usually must be encapsulated between two polyamide layers to provide support and allow smooth thinning during thermoforming as well as to improve formability and overall toughness to the multilayer structure. One typical thermoformed barrier EVOH containing multilayer structures have a polyethylene layer-tie layer-polyamide layer-EVOH layer-polyamide layer-tie layer-polyethylene layer structure.

There remains a need for a high barrier EVOH based multilayer structure useful in thermoforming applications and which further exhibits good toughness and allows smooth draw down for excellent barrier retention of the EVOH without the need of polyamide layers.

### SUMMARY OF THE INVENTION

The disclosure is for a multilayer structure and thermoformed articles made therefrom.

In one embodiment, the disclosure provides a multilayer structure comprising at least one barrier layer, said barrier layer comprising less than or equal to 12 percent, by weight of the barrier layer, of an anhydride and/or carboxylic acid functionalized ethylene/alpha-olefin interpolymer having a density in the range of from 0.855 to 0.900 g/cm³; and having a melt index (190° C./2.16 kg) of greater than 200 g/10 min; and at least 60 percent, by weight of the barrier layer, of EVOH having from 10 to 32 mole percent units derived from ethylene monomer.

In another embodiment, the disclosure provides a thin thermoformed article made from the multilayer structure.

In yet another embodiment, the disclosure provides a thick thermoformed article made from the multilayer structure.

### DETAILED DESCRIPTION OF THE INVENTION

The disclosure provides a multilayer structure and thermoformed articles made therefrom.

As used herein, the term ethylene/alpha-olefin interpolymer means a polymer prepared by the polymerization of ethylene and an alpha-olefin and optionally one or more additional monomers. Ethylene/alpha-olefin interpolymers include ethylene/alpha-olefin copolymers prepared only from ethylene monomer and an alpha-olefin monomer. Ethylene/alpha-olefin interpolymers also include polymers prepared from ethylene monomer, an alpha-olefin monomer and at least one more monomer which may also be an alpha-olefin.

In a first embodiment, the invention provides a multilayer structure comprising at least one barrier layer, said barrier layer comprising less than or equal to 12 percent, by weight of the barrier layer, of an anhydride and/or carboxylic acid functionalized ethylene/alpha-olefin interpolymer having a density in the range of from 0.855 to 0.900 g/cm³; and having a melt index (190° C./2.16 kg) of greater than 200 g/10 min; and at least 60 percent, by weight of the barrier layer, of EVOH having from 10 to 32 mole percent units derived from ethylene monomer.

All individual values and subranges from less than or equal to 12 percent by weight of the barrier layer of an anhydride and/or carboxylic acid functionalized ethylene/alpha-olefin interpolymer are included and disclosed herein. For example, the amount of the functionalized ethylene/alpha-olefin interpolymer can be from an upper limit of 12 percent by weight (wt %), or in the alternative, 11 wt %, or in the alternative 10 wt %, or in the alternative, 9 wt %.

In an alternative embodiment, the barrier layer comprises from 5 to 25 wt %, by weight of the barrier layer of an anhydride and/or carboxylic acid functionalized ethylene/alpha-olefin interpolymer having a density in the range of from 0.855 to 0.900 g/cm³; and having a melt index (190° C./2.16 kg) of greater than 200 g/10 min. All individual values and subranges from 5 to 25 wt % are included and disclosed herein; for example, the amount of anhydride and/or carboxylic acid functionalized ethylene/alpha-olefin interpolymer in the barrier layer can be from a lower limit of 5, 10, 15, or 20 wt % to an upper limit of 7.5, 12.5, 17.5, 22.5 or 25 wt %. For example, the amount of an hydride and/or carboxylic acid functionalized ethylene/alpha-olefin interpolymer in the barrier layer can be from 5 to 25 wt %, or in the alternative, from 5 to 20 wt %, or in the alternative, from 7 to 15 wt %, or in the alternative, from 8 to 18 wt %.

Any anhydride and/or carboxylic acid functionalized ethylene/alpha-olefin interpolymer may be used. Such interpolymers include, for example, ethylene/alpha-olefin interpolymers functionalized with maleic anhydride.

The anhydride and/or carboxylic acid functionalized ethylene/alpha-olefin interpolymer has a density in the range of from 0.855 to 0.900 g/cm³. All individual values and subranges from 0.855 to 0.900 g/cm³ are included and disclosed herein. For example, the density of the anhydride and/or carboxylic acid functionalized ethylene/alpha-olefin interpolymer can be from a lower limit of 0.855, 0.865, 0.875, 0.885 or 0.895 g/cm³ to an upper limit of 0.860, 0.870, 0.880, 0.890 or 0.900 g/cm³. For example, the density of the anhydride and/or carboxylic acid functionalized ethylene/alpha-olefin interpolymer can range from 0.855 to 0.900 g/cm³, or in the alternative, from 0.855 to 0.875 g/cm³, or in the alternative, from 0.875 to 0.900 g/cm³, or in the alternative, from 0.865 to 0.885 g/cm³.

The anhydride and/or carboxylic acid functionalized ethylene/alpha-olefin interpolymer has a composition, comprising at least one functionalized ethylene interpolymer, and wherein the functionalized ethylene interpolymer is formed from at least one unsaturated compound containing at least one heteroatom, and where the ethylene interpolymer that has a melt viscosity less than 50,000 cP, preferably or in the alternative, less than 40,000 cP, or in the alternative, less than 30,000 cP at 350° F. (177° C.), and a molecular weight distribution (Mw/Mn) from about 1 to 5, or in the alternative 1.1 to 5, or in the alternative from 1 to 4, or in the alternative from 1 to 3.5, or in the alternative from 1 to 3.5, or in the alternative from 1.1 to 3.5. In one embodiment, the ethylene interpolymer is an ethylene/alpha-olefin interpolymer.

In one embodiment, the at least one unsaturated compound is a carbonyl-containing compound. In a further aspect, the carbonyl-containing compound is selected from the group consisting of maleic anhydride, dibutyl maleate, dicyclohexyl maleate, diisobutyl maleate, dioctadecyl maleate, N-phenylmaleimide, citraconic anhydride, tetrahydrophthalic anhydride, bromomaleic anhydride, chloromaleic anhydride, nadic anhydride, methylnadic anhydride, alkenylsuccinic anhydride, maleic acid, fumaric acid, diethyl fumarate, itaconic acid, citraconic acid, crotonic acid, esters thereof, imides thereof, salts thereof, and Diels-Alder adducts thereof. In a further embodiment, the unsaturated compound is an anhydride, and preferably maleic anhydride.

In another embodiment, the at least one functionalized ethylene interpolymer has a density from 0.855 g/cm³ to 0.93 g/cm³, or in the alternative from 0.86 g/cm³ to 0.92 g/cm³, or in the alternative from 0.86 g/cm³ to 0.90 g/cm³. All individual values and subranges from 0.855 g/cm³ to 0.93 g/cm³ are included herein and disclosed herein. In one aspect the functionalized ethylene interpolymer is a functionalized ethylene/alpha-olefin interpolymer.

In another embodiment, the functionalized ethylene interpolymer has a melt viscosity at 350° F. (177° C.) less than 50,000 cP, or in the alternative less than 40,000 cP, or in the alternative less than 30,000 cP, or in the alternative less than 20,000 cP. In another embodiment, the functionalized ethylene interpolymer has a melt viscosity at 350° F. (177° C.) greater than 2,000 cP, or in the alternative greater than 3,000 cP, or in the alternative greater than 4,000 cP. In one embodiment, the functionalized ethylene interpolymer is a functionalized ethylene/.alpha.-olefin interpolymer.

In another embodiment, the ethylene interpolymer, and preferably an ethylene/alpha-olefin interpolymer, has a melt viscosity at 350° F. (177° C.) less than 20,000 cP, and the functionalized ethylene interpolymer, preferably a functionalized ethylene/alpha-olefin interpolymer, has a melt viscosity at 350° F. (177° C.) less than 25,000 cP. In a further embodiment, both the ethylene interpolymer, in one embodiment an ethylene/alpha-olefin interpolymer, and the functionalized ethylene interpolymer, in one embodiment a functionalized ethylene/alpha-olefin interpolymer, each has, independently, a melt viscosity at 350° F. (177° C.) greater than 2,000 cP, or in the alternative greater than 3,000 cP, or in the alternative greater than 4,000 cP.

In another embodiment, the ethylene interpolymer, and in one embodiment, an ethyelene/alpha-olefin interpolymer, has a melt viscosity at 350° F. (177° C.) less than 15,000 cP, and the functionalized ethylene interpolymer, preferably a functionalized ethylene/alpha-olefin interpolymer, has a melt viscosity at 350° F. (177° C.) less than 20,000 cP. In a further embodiment, both the ethylene interpolymer, in one embodiment an ethylene/alpha-olefin interpolymer, and the functionalized ethylene interpolymer, in one embodiment a functionalized ethylene/alpha-olefin interpolymer, each has, independently, a melt viscosity at 350° F. (177° C.) greater than 2,000 cP, or in the alternative greater than 3,000 cP, or in the alternative greater than 4,000 cP.

The barrier layer further comprises at least 60 percent by weight of the barrier layer, of EVOH having from 10 to 32 mole percent units derived from ethylene monomer. All individual values and subranges from at least 60 percent by weight EVOH are included and disclosed herein. For example, the barrier layer may comprise at least 60 wt % EVOH, or in the alternative, at least 65 wt %, or in the alternative, at least 70 wt %, or in the alternative, at least 75 wt %, or in the alternative, at least 77 wt %. The EVOH has from 10 to 32 mole percent units derived from ethylene monomer. All individual values and subranges from 10 to 32 wt % are included and disclosed herein; for example, the amount of units derived from ethylene monomer can be from a lower limit of 10, 15, 20 or 25 wt % to an upper limit of 12, 17, 22, 27 or 32 wt %. For example, the amount of units derived from ethylene monomer can be from 10 to 32 mol %, or in the alternative, from 10 to 22 mol %, or in the alternative, from 20 to 32 mol %, or in the alternative, from 15 to 25 mol %, or in the alternative, from 24 to 30 mol %.

In an alternative embodiment, the invention provides the multilayer structure according to any one of the embodiments disclosed herein except that the barrier layer further comprises one or more oxygen scavengers or other functional additives. Exemplary oxygen scavengers include sodium sulfite, sodium pyrosulfite, sodium thiosulfate, sodium dithionite and sodium hypophosphite. Exemplary functional additives include calcium oxide, talc, and other mineral fillers.

In an alternative embodiment, the invention provides the multilayer structure according to any one of the embodiments disclosed herein except that the barrier layer has a thickness in the range of from 1 to 150 microns. All individual values and subranges from 1 to 150 microns are included and disclosed herein. For example, the thickness of the barrier layer can range from a lower limit of 1, 5, 25, 45, 65, 85, 105, 125 or 145 microns to an upper limit of 10, 30, 50, 70, 90, 110, 130 or 150 microns. For example, the thickness of the barrier layer can be from 1 to 150 microns, or in the alternative, from 3 to 75 microns, or in the alternative, from 75 to 150 microns, or in the alternative, from 35 to 135 microns.

In an alternative embodiment, the invention provides the multilayer structure according to any one of the embodiments disclosed herein except that the multilayer structure has a thickness in the range of from 50 microns to 3000 microns. All individual values and subranges are included and disclosed herein. For example, the thickness of the multilayer structure can be from a lower limit of 50, 550, 1250, 2250, or 2750 microns to an upper limit of 60, 600, 1500, 2500 or 3000 microns.

In an alternative embodiment, the invention provides the multilayer structure according to any one of the embodiments disclosed herein except that the multilayer structure further comprises an external layer made from a resin which comprises linear low density polyethylene, ultra low density polyethylene, propylene/ethylene interpolymer, propylene/alpha-olefin interpolymer, polyethylene terephthalate, polypropylene, polylactic acid, or any combination thereof.

In an alternative embodiment, the invention provides the multilayer structure according to any one of the embodiments disclosed herein except that the multilayer structure further comprises one or more additional layers which comprise a polyamide.

In an alternative embodiment, the invention provides the multilayer structure according to any one of the embodiments disclosed herein except that the multilayer structure further comprises a seal layer made from a resin which comprises linear low density polyethylene, low density polyethylene, ultra low density polyethylene, propylene/ethylene interpolymer, propylene/alpha-olefin interpolymer, or any combination thereof.

In an alternative embodiment, the invention provides the multilayer structure according to any one of the embodiments disclosed herein except that the multilayer structure further comprises a tie layer adjacent to the barrier layer.

In an alternative embodiment, the invention provides the multilayer structure according to any one of the embodiments disclosed herein except that the multilayer structure has a thickness of from 260 to 3000 microns. All individual values and subranges from 260 to 3000 microns are included and disclosed herein. For example, the thickness of the multilayer structure can be from a lower limit of 260, 560, 1350, 2000 or 2750 microns to an upper limit of 350, 750, 1500, 2500 or 3000 microns. For example, the thickness of the multilayer structure can be from 260 to 3000 microns, or in the alternative, from 260 to 1750 microns, or in the alternative, from 1750 to 3000 microns, or in the alternative, from 500 to 2250 microns.

In another embodiment, the invention further provides a thermoformed article comprising the multilayer structure having a thickness from 260 to 3000 microns wherein the article is a tray or container. Trays or containers include for example, deep thermoformed articles such as are used for fruit, cheese sauce, and pet food packaging.

In an alternative embodiment, the instant invention provides a multilayer structure having a thickness from 50 to 260 microns. All individual values and subranges from 50 to 260 microns are included and disclosed herein; for example, the thickness of the multilayer structure can range from a lower limit of 50, 75, 100, 125, 150, 175, 200, 225, or 250 microns to an upper limit of 60, 85, 110, 135, 160, 185, 210, 235 or 260 microns. For example, the thickness of the multilayer structure can be from 50 to 260 microns, or in the alternative, from 50 to 155 microns, or in the alternative, from 150 to 260 microns, or in the alternative, from 75 to 245 microns.

In another embodiment, the invention provides a thermoformed article comprising the multilayer structure having a thickness from 50 to 260 microns wherein the article is a barrier film.

Such barrier films are used, for example, in oxygen sensitive food (such as cheese or meat) or beverage packaging.

In one embodiment, the barrier film has a five layer structure, illustrated as A/B/C/D/E wherein A is an external layer, B is a first tie layer, C is the barrier layer, D is a second tie layer and E is a seal layer. The external layer may be made from one or more resins selected from the group consisting of linear low density polyethylene, ultra low density polyethylene, propylene/ethylene interpolymers, propylene/alpha olefin copolymers and blends of any two or more thereof. The first and second tie layers may have the same or different compositions. Any appropriate tie layer material may be used. Exemplary tie layer composition includes maleic anhydride functionalized polyolefins. Any appropriate material may be used for the seal layer, including for example, linear low density polyethylene, propylene/ethylene interpolymers, propylene/alpha olefin copolymers and blends of any two or more thereof.

### EXAMPLES

The following examples illustrate the present invention but are not intended to limit the scope of the invention. In the examples which follow, the term “reactive modifier” refers to an anhydride and/or carboxylic acid functionalized ethylene/alpha-olefin interpolymer having a density in the range of from 0.855 to 0.900 g/cm³; and having a melt viscosity less than 50,000 cP at 350° F. (177° C.).

### Example 1

The EVOH polymer, EVOH 1 contains 32 mol % ethylene, and is commercially available from Kuraray America, Inc. and sold under the trade name of EVAL* polymer. The reactive modifier used in the Example is prepared as follows:

### Synthesis of Component A—MAH-g-EO1:

The following materials are used to make the reactive modifier used in the Examples:

1. Base resin is low molecular weight ethylene-octene copolymer having a density of 0.87 g/cc;

2. Maleic Anhydride (MAH);

3. HYDROBRITE 380 which is a hydrotreated paraffinic oil to dilute peroxide as needed. (1:1 ratio of peroxide:oil) and which is commercially available from Sonneborn, LLC (Parsippany, N.J., USA); and

4. LUPEROX 101 which is 2,5-bisb(tert-butylperoxy)-2,5-dimethylhexane (290.44 g/mol) which is commercially available from Arkema, Inc. (King of Prussia, Pa., USA).

The reactive modifier is made using a co-rotating twin screw extruder (TSE). The process is summarized in the following steps: (a) base resin polymer pellets are fed into the extruder hopper of the extruder by a gravimetrically, controlled auger feeder, at the desired polymer feed rate; (b) MAH is injected into the barrel; (c) peroxide is added and may be diluted with mineral oil solution as needed, at a target feed rate; (d) kneading blocks distribute the reactive ingredients and heated the polymer melt through mechanical energy dissipation, and the reaction occurs following thermal decomposition of peroxide initiator; (e) volatile unreacted components and byproducts are removed at a vacuum port; (f) the melt is cooled in the final barrel section and is fed to a gear pump; (g) the gear pump feeds a die, from which the melt goes to an underwater pelletizer. A pellet slurry cooling line of sufficient length is used to achieve residence time greater than 60 seconds, to cool pellets to less than 25° C. The pelletized product is dried and collected.

Once the reactive modifier has been made the EVOH resin compounded with the reactive modifier is prepared using a large scale Century-ZSK-40 37.12L/D extruder with 9 barrels using a mixing screw design. The underwater diverter valve assembly is equipped with a 6 hole (3.175 mm hole diameter) under water die. The first barrel section is set at 25° C. whereas the remaining barrel zones are set between 25° C. and 225° C. The screw speed is set to establish the targeted feed rate of 68 kg/hr. This results in melt temperatures between 220-229° C. The material is underwater pelletized used a Gala underwater pelletizer.

After compounding the polymer is stored in a moisture proof bag and further dried prior to the blown film fabrication step. The sample is dried using a hot air recirculation oven using the recommended drying temperatures for EVOH.

A coextruded 5 layer film sample was produced on an Alpine 7-Layer blown film run by using the same polymer feed in two of the 7 layers represented as layers A/B/C/D/E/F/G with the “A” layer being in the inside of the bubble. The 5 layer structure is achieved by combining the “A” and “B” layers and the “F” and “G” layers. The individual feed lines are all 50 mm 30:1 L/D grooved feed extruders where each extruder was fed from a 4 component blender. The 7 extruders combined produce a feed to the 75 mm 7-layer flat die (30/11/18/11/30) of 23 kg/hr. The blow up ratio is 2.38. The barrel temperatures range from 166° C. to 232° C. The standard frost line height is 30 cm. The film thickness is maintained using an auto profile air ring system and an IBC.

### Results

No characterization of the compounded pellets is done. All of the data is for blown film articles.

A 5 layer structure is produced using the Alpine 7 layer line with a target structure of 34 micron thickness. All of the compounds were prepared using the single screw compounding line.

A: 40.8% of the film thickness is layer A which comprises a polyethylene (0.917 density, 0.8 MI)

B: 6.6% of the film thickness is layer B which comprises a polyethylene based tie layer (0.920 density, 1 MI)

C: 5.5% of the film thickness is layer C which comprises a blend of 90 wt % EVOH1+10 wt % reactive modifier)

D: 6.6% of the film thickness is layer D which comprises a polyethylene based tie layer (0.920 density, 1 MI)

E: 40.8% of the film thickness is layer E which comprises a polyethylene (0.917 density, 0.8 MI)

This structure was produced and the film was tested using conventional film testing protocols as indicated in Table 1.

TABLE 1

| | | | Example 1 |
|---|---|---|---|
| | | | (90% EVOH1 + |
| | ASTM | | 10% reactive modifier |
| Property | Method | Unit | in layer C) |
| Dart | D1709 | gram | 247 |
| Secant Modulus CD at 1% | D882 | PSI | 52662 |
| Secant Modulus MD at 1% | D882 | PSI | 50767 |
| Elmendorf Tear CD | D1922 | gram | 2064 |
| Elmendorf Tear MD | D1922 | gram | 1228 |

### Example 2

A multi-layer structure, having layers ABCDEFGGFEDCBA as shown in Table 2, is produced using an Alpine 7 layer line to make two seven layer films which are then collapsed with a target structure of 6 mils (152 micron) thickness. All of the compounds were prepared using the single screw compounding line and are obtained by collapsing the blown bubble.

TABLE 2

| | | Layer | % of total | | |
|---|---|---|---|---|---|
| | | thickness | film | I₂ or MFR* | Density |
| Layer | Component | (mils) | thickness | g/10 min | g/cc |
| A | PP1 | 0.72 | 12 | 0.7 | 0.893 |
| B | PE2 | 0.54 | 9 | 0.7 | 0.909 |
| C | Tie Layer | .027 | 4.5 | 1.7 | 0.91 |
| D | EVOH2 | 0.3 | 5 | 1.7 | 1.17 |
| E | Tie layer | 0.27 | 4.5 | 1.7 | 0.91 |
| F | PE2 | 0.36 | 6 | 0.7 | 0.909 |
| G | PE3 | 0.54 | 9 | 3 | 0.875 |
| G | PE3 | 0.54 | 9 | 3 | 0.875 |
| F | PE2 | 0.36 | 6 | 0.7 | 0.909 |
| E | Tie layer | 0.27 | 4.5 | 1.7 | 0.91 |
| D | EVOH2 | 0.3 | 5 | 1.7 | 1.17 |
| C | Tie layer | 0.27 | 4.5 | 1.7 | 0.91 |
| B | PE2 | 0.54 | 9 | 0.7 | 0.909 |
| A | PP1 | 0.72 | 12 | 0.7 | 0.893 |
| Total | | 6 | 100 | | |

*I₂ applies to ethylene-based polymers (PE) and MFR applies to propylene based polymers (PP).

PP1 is a blend of 35 wt % rPP 01R25, a random propylene-based copolymer, having a density of 0.9 g/cc (g/cm³) and an MFR of 0.5 g/10 min and 65 wt % of VERSIFY 2000, a propylene-ethylene copolymer, having a density of 0.89 g/cc and an MFR of 0.8 g/10 min.
PE2 is a blend 80 wt % ATTANE 4203, an ethylene based polymer, having a density of 0.905 g/cc and an I₂ of 0.85 g/10 min and 20 wt % AGILITY 2001, an ethylene-based polymer, having a density of 0.924 g/cc and an I₂ of 0.4 g/10 min.
PE3 is 100 wt % AFFINITY KC8852, an ethylene-octene copolymer, having a density of 0.875 g/cc and an I₂ of 3.0 g/10 min.
Tie layers are each 100% AMPLIFY TY 1451, a functional polymer, having a density of 0.91 g/cc and an I₂ of 1.7 g/10 min.
The rPP, ATTANE, AGILITY, AMPLIFY, and VERSIFY polymers are commercially available from The Dow Chemical Company (Midland, Mich., USA).
The polymer EVOH2 contain 38 mol % ethylene and is commercially available from Kuraray America, Inc and sold under the trade name of EVAL* polymer.

### Results

Corner thickness on thermoformed trays have been measured on two samples, one without modifier and one with 7 wt % modifier in the EVOH layer, as shown in Table 3. The thickness of the corners is higher when the EVOH is blended with the modifier.

TABLE 3

Example 2

| | | Example 2.2 |
|---|---|---|
| | Example 2.1 | (93% EVOH2 + |
| | (100% EVOH2 in | 7% reactive modifier |
| | layers C & G) | in layers C & G) |
| average 100*corner | 13% | 16% |
| thickness/film | | |
| thickness | | |
| stdev 100*corner | 3% | 3% |
| thickness/film | | |
| thickness | | |

### Example 3

Coextruded 3 layer film samples (having the layer structure ABC) were produced on a Collin cast line by using the same polymer feed in the two skin layers and an EVOH blend in the core layer. The output is 12 kg/h, air gap 1 inch, melt temperature 230° C., die gap 50 mils, the sheet thickness is 50 mils and the temperature of the chill rolls is 35° C. The film samples of Example 3 have the structure shown below:

A: 45% of the film thickness is layer A which comprises 75 wt % D115A and 25 wt % tie layer
B: 10% of the film thickness is layer B which comprises 100% EVOH3 or EVOH4 (or 95% EVOH3 or EVOH4+5% reactive modifier)
C: 45% of the film thickness is layer C which comprises 75 wt % D115A and 25 wt % tie layer
The tie layer used in the films of Example 3 was a functional polymer having a density of 0.875 g/cc and an I₂ of 1.3 g/10 min. The polymers EVOH3 and EVOH4 contain 27 mol % ethylene and 24 mol % ethylene respectively and are commercially available from Kuraray America, Inc and sold under the trade name of EVAL* polymer. D115A is a polypropylene commercially available from Braskem (Philadelphia, Pa., USA) and having an MFR of 11 g/10 min.

### Results

Trays were made on a plug assist thermoformer. To evaluate the thermoformability the thickness of the corners have been measured
Example 3.1: EVOH3 no modifier
Example 3.2: EVOH3 with 5% modifier in the EVOH layer
Example 3.3: EVOH4 no modifier
Example 3.4: EVOH4 with 5% modifier in the EVOH layer
   Results, shown in Table 4, show thicker corners when EVOH is blended with the modifier.

TABLE 4

| | Example 3 | | | |
|---|---|---|---|---|
| | | Example 3.2 | Example | Example 3.4 |
| | Example | (95% | 3.3 | (95% |
| | 3.1 | EVOH3 + | (100% | EVOH4 + |
| | (100% | 5% reactive | EVOH 4 | 5% reactive |
| | EVOH3 in | modifier in | in layer | modifier in |
| | layer B) | layer B) | B) | layer B) |
| average 100*corner | 66.13 | 67.25 | 55.82 | 57.80 |
| thickness/sheet | | | | |
| thickness | | | | |
| stdev 100*corner | 5.04 | 2.94 | 6.377 | 4.524 |
| thickness/sheet | | | | |
| thickness | | | | |

### Test Methods

Additional Test methods include the following:

Polymer density is measured according to ASTM D792.

Oxygen Transmission Rate was measured according to ASTM D 3985.

Dart Impact resistance was measured according to ASTM D 1709.

Secant Modulus CD and MD were measured according to ASTM D 882.

Elmendorf Tear CD and MD were measured according to ASTM D 1922.

Melt index (I₂, or MI) of an ethylene-based polymer is measured in accordance with ASTM D-1238, condition 190° C./2.16 kg. For high I₂ polymers (I₂ greater than, or equal to, 200 g/10 min, melt index is preferably calculated from Brookfield viscosity as described in U.S. Pat. Nos. 6,335,410; 6,054,544; 6,723,810. I₂ (190° C./2.16 kg)=3.6126[10(log(η)−6.6928)/−1.1363]−9.31851, where η=melt viscosity, in cP, at 350° F. (177° C.).

MFR (melt flow rate) of propylene based polymers are measured according to ASTM D-1238, condition 230° C./2.16 kg.

Corner and sheet thickness testing was conducted using a MAGNA-MIKE 8500 Hall Effect thickness gage, which is commercially available from Olympus Corporation (Waltham, Mass., USA).

The present invention may be embodied in other forms without departing from the spirit and the essential attributes thereof, and, accordingly, reference should be made to the appended claims, rather than to the foregoing specification, as indicating the scope of the invention.

1. A multilayer structure comprising at least one barrier layer, said barrier layer comprising
a. less than or equal to 12 percent, by weight of the barrier layer, of an anhydride and/or carboxylic acid functionalized ethylene/alpha-olefin interpolymer having a density in the range of from 0.855 to 0.900 g/cm³; and having a melt viscosity less than 50,000 cP at 350° F. (177° C.); and
b. at least 60 percent, by weight of the barrier layer, of EVOH having from 10 to 32 mole percent units derived from ethylene monomer.

2. The multilayer structure according to claim 1 wherein the functionalized ethylene/alpha-olefin interpolymer has been functionalized with maleic anhydride.

3. The multilayer structure of claim 1 wherein the barrier layer further comprises one or more oxygen scavengers.

4. The multilayer structure of claim 1 wherein the ethylene/alpha-olefin interpolymer has a melt viscosity less than 30,000 cP at 350° F. (177° C.).

5. The multilayer structure of claim 1 wherein the barrier layer has a thickness in the range of from 5 to 150 microns.

6. The multilayer structure of claim 1 wherein the EVOH has from 24 to 30 mol % units derived from ethylene.

7. The multilayer structure of claim 1 wherein the multilayer structure has a total thickness in the range of from 50 microns to 3000 microns.

8. The multilayer structure of claim 1 further comprising an external layer made from a resin which comprises linear low density polyethylene, ultra low density polyethylene, propylene/ethylene interpolymer, propylene/alpha-olefin interpolymer, polyethylene terephthalate, polypropylene, polylactic acid, or any combination thereof.

9. The multilayer structure of claim 1 further comprising one or more additional layers which comprise a polyamide.

10. The multilayer structure of claim 1 further comprising a seal layer made from a resin which comprises linear low density polyethylene, low density polyethylene, ultra low density polyethylene, propylene/ethylene interpolymer, propylene/alpha-olefin interpolymer, or any combination thereof.

11. The multilayer structure of claim 1, further comprising a tie layer adjacent to the barrier layer.

12. The multilayer structure of claim 1 wherein the multilayer structure has a thickness of from 260 to 3000 microns.

13. A thermoformed article comprising the multilayer structure according to claim 12 wherein the article is a tray or container.

14. The multilayer structure according to claim 1, wherein the multilayer structure has a thickness from 50 to 260 microns.

15. A thermoformed article comprising the multilayer structure according to claim 14 wherein the article is a barrier film.
